(19) United States
(12) Patent Application Publication
(10) Pub. No.: US 2009/0235287 A1
(43) Pub. Date: Sep. 17, 2009

(54) Conveyance Device and Recording Meduim Drive Device

(76) Inventors: Yoshihiro Ichikawa, Saitama (JP); Eiji Hoshinaka, Saitama (JP); Yosuke Amitani, Saitama (JP)

Correspondence Address: KRATZ, QUINTOS & HANSON, LLP, 1420 K Street, N.W., Suite 400, WASHINGTON, DC, 20005, US

(21) Appl. No.: 12/083,225

(22) PCT Filed: Oct. 2, 2006
(86) PCT No.: PCT/JP2006/319663

§ 371 Date: Apr. 7, 2008

(30) Foreign Application Priority Data
Oct. 12, 2005 (JP) 2005-297728

(51) Int. Cl. G11B 17/04

(52) U.S. Cl. 720/601; G9B/17.013

(57) ABSTRACT

A disc unit includes a push arm for providing a predetermined clearance between a periphery of a large-diameter disc and a guide lever used for guiding insertion and ejection of the large-diameter disc. The clearance is formed by moving the guide lever toward a left wall when the large-diameter disc is clamped on a turntable. With this arrangement, when the large-diameter disc is mounted on the turntable, the rotation of the large-diameter disc is not hindered.

### TECHNICAL FIELD

The present invention relates to a transfer unit for inserting and ejecting a disc recording medium, and a recording-medium driver provided with the transfer unit.

### BACKGROUND ART

There have been conventionally known disc units capable of internally holding disc recording mediums of different diameters. (e.g., see Patent Document 1).

Patent Document 1 discloses a disc reproducer that transfers a disc by a transferring roller and positions the disc above a turntable by a positioning mechanism. The positioning mechanism includes: right and left positioning levers rotatably supported by fulcrum pins and crossed with each other; a switching lever having fulcrum pins engaged with engaging holes of the positioning levers, the switching lever being rotated by a solenoid. In addition, in the vicinity of a disc insertion opening of the disc reproducer, a central sensor, right and left sensors provided respectively to the right and the left of the central sensor and an outer sensor are provided so as to judge the diameter of a disc inserted from the disc insertion opening. When the insertion of a large-diameter disc is detected by the sensor(s), the switching lever is rotated to rotate the right and left positioning levers so that positioning pins are the most remotely spaced apart from each other. On the other hand, when the insertion of a small-diameter disc is detected, the right and left positioning levers are rotated so that the positioning pins comes the closest to each other.

[Patent Document 1] JP-A-02-118955 (pages 3 to 5, FIGS. 1 to 7)

### DISCLOSURE OF THE INVENTION

### Problems to be Solved by the Invention

However, according to such a conventional disc reproducer as disclosed in Patent Document 1, the disc is clamped on the turntable after the disc is held by the right and left levers. At this time, since a clearance is not sufficient when the disc is kept guided by the right and left levers, rotation of the disc may be hampered.

An object of the present invention is to provide a transfer unit and a recording-medium driver that can favorably hold a disc without hampering a rotation of the disc.

### Means for Solving the Problems

A transfer unit according to an aspect of the present invention includes: a guide member that guides a disc recording medium to a position where a disc holder disposed inside a unit body is capable of holding the recording medium, the guide member being movable in a direction to be close to or away from the recording medium; a guide-movement controlling member that moves the guide member away from the recording medium while the disc holder holds the recording medium.

A recording-medium driver according another aspect of the present invention includes: the above-described transfer unit; the disc holder that holds the recording medium transferred by the transfer unit; a mount on which the disc holder is provided, the mount being movable in an up-and-down direction; an information processor that performs at least one of writing information in the recording medium held by the disc holder and reading information from the recording medium; and the unit body that internally houses the transfer unit, the disc holder, the mount and the information processor, the unit body comprising an insertion-and-ejection opening for inserting and ejecting the recording medium.

### BRIEF DESCRIPTION OF DRAWINGS

FIG. 1 is a top view showing an inside of a unit body of a disc unit according to an embodiment of the present invention.

FIG. 2A is an enlarged top view showing a push arm provided inside the disc unit, in which the push arm is not in engagement with a guide lever.

FIG. 2B is an enlarged top view showing the push arm provided inside the disc unit, in which the push arm is in engagement with the guide lever.

FIG. 2C is an enlarged top view showing the push arm provided inside the disc unit, in which the push arm in FIG. 2B is moved toward a left wall.

FIG. 3 is a top view showing the inside of the unit body of the disc unit when an insertion of a large-diameter disc is initiated or when the large-diameter disc has been ejected.

FIG. 4 is a top view showing the inside of the unit body of the disc unit when a large-diameter disc is being transferred.

FIG. 5 is a top view showing the inside of the unit body of the disc unit when a large-diameter disc has been inserted.

FIG. 6 is a top view showing the inside of the unit body of the disc unit when a large-diameter disc is being clamped against a turntable.

### EXPLANATION OF CODES

1 . . . optical disc serving as a recording medium
1A . . . large-diameter disc serving as a recording medium
10 . . . unit body
11 . . . slot serving as an insertion-and-ejection opening
21 . . . mount
23 . . . turntable serving as a disc holder
24 . . . information processor
41 . . . disc guide mechanism serving as a transfer unit
100 . . . disc unit serving as a recording-medium driver
411 . . . guide lever (a component of a guide member)
411C . . . rotation-restricting pin serving as an engaging portion
412 . . . disc guide (a component of a guide member)
416 . . . push arm serving as a guide-engaging member (a component of a guide-movement controlling member)
416A . . . pin-locking groove serving as an engaging groove
416C . . . push arm-biasing spring as a biasing member
424 . . . slide stopper serving as a movement controlling member (a component of a guide-movement controlling member)

### BEST MODE FOR CARRYING OUT THE INVENTION

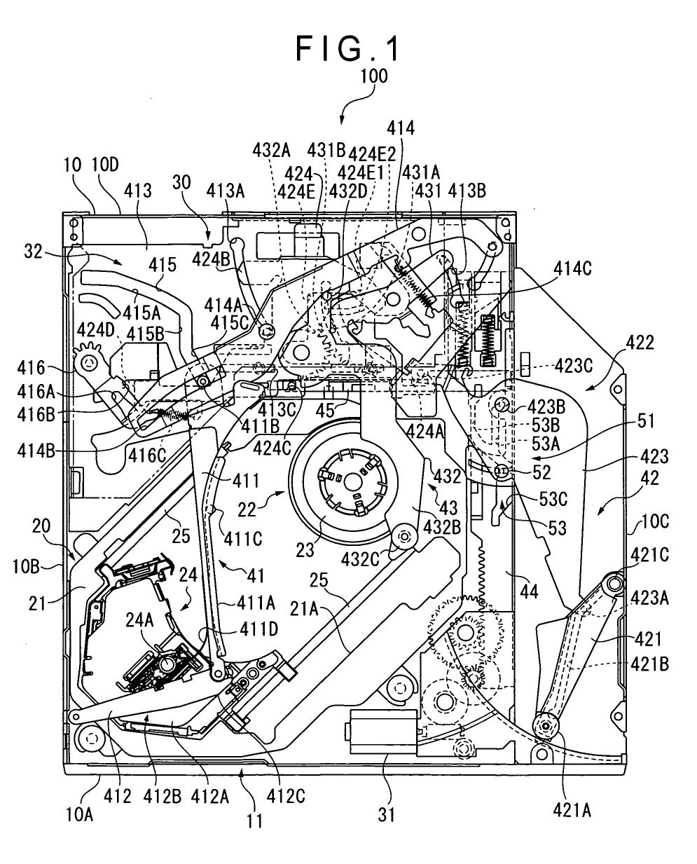

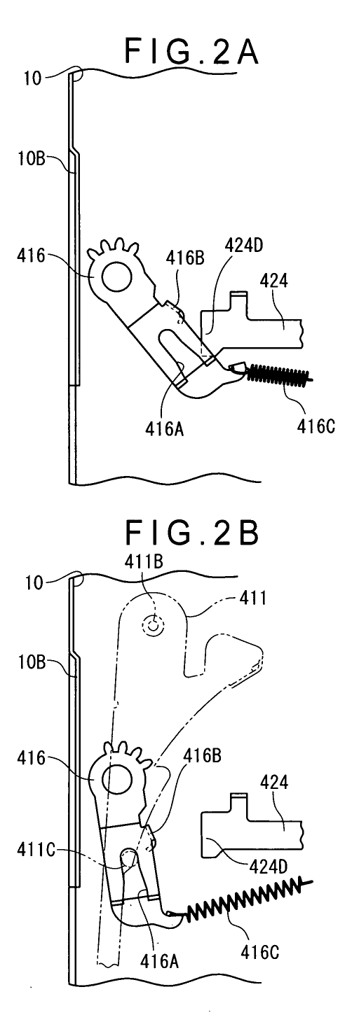

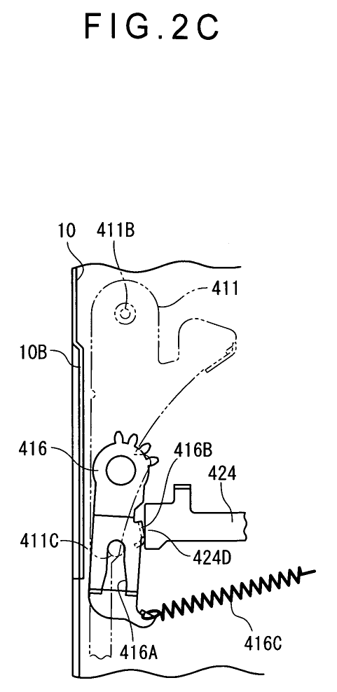

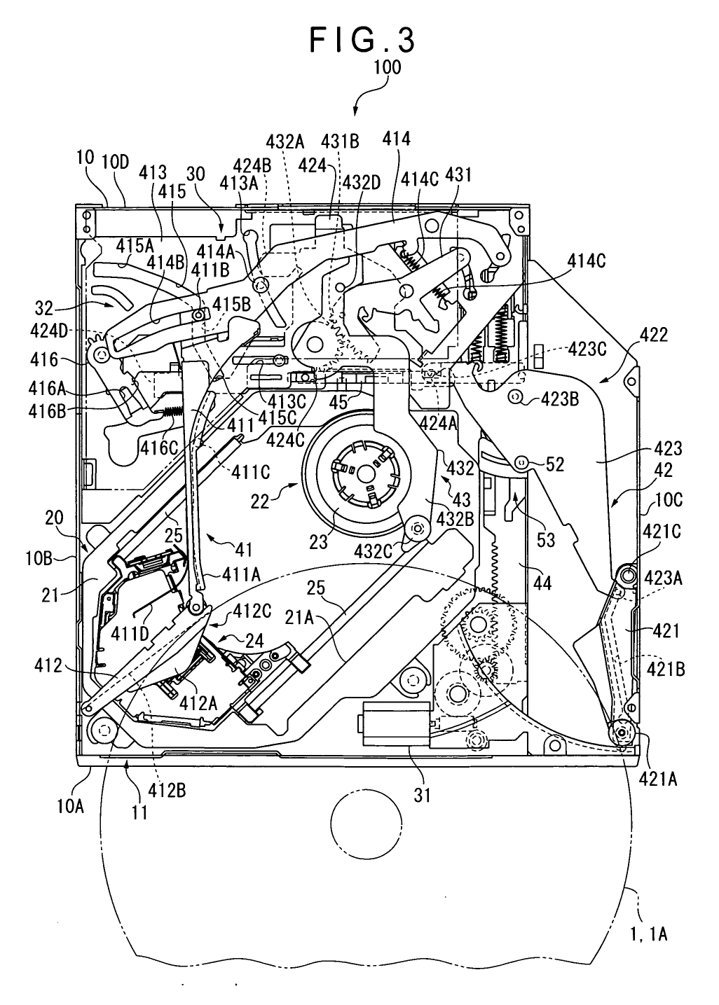

An embodiment of the present invention will be described below with reference to the attached drawings. FIG. 1 is a top view schematically showing an inside of a disc unit according to an embodiment of the present invention. FIG. 2A is an enlarged top view showing a push arm provided inside the disc unit, in which the push arm is not in engagement with a guide lever. FIG. 2B is an enlarged top view showing the push arm provided inside the disc unit, in which the push arm is in engagement with the guide lever. FIG. 2C is an enlarged top view showing the push arm, in which the push arm in FIG. 2B is moved toward a left wall.

[Arrangement of Disc Unit]

In FIG. 1, the numeral 100 denotes a disc unit serving as a recording medium driver according the embodiment of the present invention. The disc unit 100 performs such information processing as reading-processing or recording-processing on an optical disc 1 (disc recording medium) detachably mounted thereon, thereby reading information recorded in a recording surface (not shown) provided on at least one surface of the optical disc 1 or recording a variety of information on the recording surface of the optical disc 1. Although an example of the disc unit 100 is a so-called thinned slot-in type unit that is mounted on an electrical equipment such as a portable personal computer, the disc unit 100 itself may be configured as, for instance, a game machine or a reproducer that performs processing for recording (e.g. video-recording) or reproducing image data. In addition, the disc unit 100 can accept a large-diameter disc 1A having a diameter of 12 cm and a small-diameter disc 1B having a diameter of 8 cm as the optical disc 1. The disc recording medium is not limited to the optical disc 1 but may be other disc recording mediums such as a magnetic disc or a magnetic optical disc. The disc unit 100 includes a substantially box-shaped unit body 10 having an inner space, an exemplary material of which is a metal. In the unit body 10, a lower side of the unit body 10 shown in FIG. 1 may be referred to as a front face 10A, a left lateral wall of the unit body 10 shown in FIG. 1 may be referred to as a left wall 10B, a right lateral wall of the unit body 10 shown in FIG. 1 may be referred to as a right wall 10C and a side opposite to the front face 10A of the unit body 10 shown in FIG. 1 may be referred to as a rear face 10D.

The unit body 10 internally includes a disc processor 20 (a so-called traverse mechanism), a transfer unit 30 for transferring the optical disc 1, and a control circuit (not shown) serving as a circuit board. The front face 10A of the unit body 10 is provided with a slot 11 (insertion-and-ejection opening) for inserting/ejecting the optical disc 1, the slot 11 extending in the right-and-left direction of FIG. 1.

The disc processor 20 includes a plate-like mount 21 whose one end is swingably supported by the unit body 10, an exemplary material of which is metal plate. The mount 21 longitudinally extends from the left wall 10B of the unit body 10 near the front face 10A toward the center position of the unit body 10. The mount 21 is longitudinally cut out to substantially centrally form a longitudinal processor opening 21A. A disc rotation driver 22 is disposed near a first end of the processor opening 21A of the mount 21, i.e., substantially at the center of the unit body 10. The disc rotation driver 22 includes a spindle motor (not shown), and a turntable 23 (disc holder) provided integrally with an output shaft of the spindle motor. The spindle motor is controllably connected to the control circuit and driven by electricity supplied from the control circuit. The turntable 23, which is provided substantially at the center inside the unit body 10, is a driver for rotating the optical disc 1.

The mount 21 includes an information processor 24. The information processor 24, which is supported by a pair of guide shafts 25 while bridging the guide shafts 25, is moved toward and away from the turntable 23 within the processor opening 21A by a moving mechanism (not shown). The information processor 24 has a pickup that includes: a light source (not shown); a pick-up lens 24A for converging light of the light source; and a light sensor (not shown) for detecting specular light reflected from the optical disc 1.

The transfer unit 30 includes: a transfer motor 31 disposed in the unit body 10 to be operationally controlled by, for instance, the control circuit; and a link mechanism 32 operated by driving of the transfer motor in an interlocking manner.

The link mechanism 32 includes: a disc guide mechanism 41 disposed inside the unit body 10 near the slot 11 and the left wall 10B; a disc-diameter detecting mechanism 42 disposed inside the unit body 10 near the slot 11 and the right wall 10C; a disc ejecting mechanism 43 for ejecting the optical disc mounted on the turntable 23; and a first driving cam 44 and a second driving cam 45 for swinging the mount 21.

The disc guide mechanism 41 includes: a guide lever 411 (guide member) for guiding the insertion and ejection of the optical disc 1; a disc guide 412 connected to the guide lever 411 near the front face 10A; a bridge plate 413 as a protection plate; an 8 cm arm 414 rotatably provided on the bridge plate 413; and a push arm 416 as a guide engaging member. The guide member according to the present invention is provided by the guide lever 411 and the disc guide 412 while a guide-movement controlling member is provided by the push arm 416 and a slide stopper 424 serving as a later-described movement controlling member. The transfer unit of the present invention is provided by the guide lever 411, the disc guide 412, the push arm 416 and the slide stopper 424.

The guide lever 411 is a rod-like member that is longitudinal in the disc inserting/ejecting direction. A plastic guide portion 411A for guiding the movement of the optical disc 1 in the inserting/ejecting direction is fixed on an inward lateral of the guide lever 411 (lateral facing the direction in which the optical disc 1 is inserted). The guide portion 411A, which is provided with a guide groove concaved toward the left wall 10B, guides the optical disc 1 by slidably contacting the periphery of the optical disc 1 with the guide groove. The lateral of the guide lever 411 is inwardly bent where the lateral is continued from the guide portion 411A near the rear face 10D, thereby restricting the movement of the optical disc 1. The guide portion 411A is provided with a rotation-restricting pin 411C (engaging portion) that downwardly protrudes. The rotation-restricting pin 411C is positioned so as not to interfere with the mount 21 when the guide lever 411 is moved to a position corresponding to the small-diameter disc 1B near the disc guide 412 (i.e., near the front face 10A).

A guide pin 411B that penetrates from the top to the bottom is fixed on an end of the guide lever 411 adjacent to the rear face 10D. The guide pin 411B is locked by the later-described bridge plate 413 and the 8 cm arm 414. The disc guide 412 is rotatably connected to an end of the guide lever 411 adjacent to the front face 10A.

The end of the guide lever 411 adjacent to the front face 10A is further provided with a plate spring 411D opposed to the left wall 10B. The plate spring 411D inwardly biases a connecting portion of the guide lever 411 and the disc guide 412 when the guide lever 411 is moved toward the left wall 10B. With this arrangement, the connecting portion of the guide lever 411 and the disc guide 412 is prevented from bending outwardly.

The disc guide 412 is longitudinally formed, whose first end is rotatably mounted in the vicinity of the left wall 10B of the unit body 10. In addition, as described above, a second end of the disc guide 412 is rotatably connected to the end of the guide lever 411. With this arrangement, the end of the guide lever 411 adjacent to the front face 10A can be rotationally moved along a circular arc described around the first end of the disc guide 412 with radius of a length of the disc guide 412. An inwardly-protruding flange 412A is formed below the disc guide 412. A slide-contact surface 412B, with which the optical disc 1 is slidably in contact when being inserted, is formed along the flange 412A. The connecting portion of the disc guide 412 and the guide lever 411 serves as a pressing portion 412C for pressing the periphery of the optical disc 1 toward the front face 10A when the optical disc 1 is ejected.

The bridge plate 413 extends both in the right and left directions near the rear face 10D of the unit body 10. The bridge plate 413 covers the above-described control circuit from the above so as to protect the control circuit. Near the left wall 10B, the bridge plate 413 is provided with a leading guide groove 415 (leading guide portion) that extends from a rear corner of the unit body 10 toward the inner central position.

The leading guide groove 415 includes: an arc groove 415A (first guide) formed to be substantially parallel to the rotation locus described by the connecting portion of the guide lever 411 and the disc guide 412; a linear groove 415B (second guide) continued from the arc groove 415A to extend substantially along the inserting/ejecting direction of the optical disc 1; and an oblique groove (second groove) continued from the linear groove 415B to be oblique to the linear groove 415B by a predetermined angle toward the center position of the unit body 10. The leading guide groove 415 is engaged with the guide pin 411B that downwardly protrudes from the guide lever 411, thereby guiding the movement of the guide lever 411. The linear groove 415B is arranged such that a perpendicular line drawn from the center of the turntable 23 to the extension of the linear groove 415B substantially equals to the radius of the small-diameter disc 1B.

The bridge plate 413 rotatably supports the 8 cm arm 414 near the right wall 10C. The bridge plate 413 is provided with arm restricting grooves 413A centrally and near the right wall 10C. The arm restricting grooves 413A are arced around the support position of the 8 cm arm 414 to restrict a rotation region of the 8 cm arm 414.

The bridge plate 413 also rotatably supports an assist arm 431 of the later-described disc ejecting mechanism 43 near the right wall 10C. An assist restricting groove 413B is arced around the rotation center of the assist arm 431. Substantially at the center of the bridge plate 413, an ejection arm 432 meshed with the assist arm 431 is rotatably supported. The bridge plate 413 is provided with a control groove 413C near the front face 10A, which longitudinally extends in the right-and-left direction.

As described above, the 8 cm arm is rotatably supported by the bridge plate 413 near the right wall 10C. The 8 cm arm 414 includes an arm restricting pin 414A that downwardly protrudes. The arm restricting pin 414A is locked with the arm restricting groove 413A of the bridge plate 413. The distal end of the 8 cm arm 414 is provided with a guide link groove 414B that extends along the longitudinal direction of the 8 cm arm 414. The guide link groove 414B is locked with the guide pin 411B that upwardly protrudes from the guide lever 411. In the vicinity of the support position of the 8 cm arm 414, an arm biasing spring 414C for biasing the distal end (i.e., end adjacent to the left wall 10B) of the 8 cm arm toward the front face 10A is provided. The arm biasing spring 414C constantly biases the 8 cm arm 414 counterclockwise. The 8 cm arm 414 biases the guide lever 411 such that the guide pin 411B returns to an initial state to be positioned at a distal position of the oblique groove 415C of the leading guide groove 415.

The push arm 416 is rotatably provided on the bridge plate 413 near the left wall 10B. As shown in FIG. 2A, the push arm 416, which is longitudinally formed, is provided with the pin locking groove 416A (engaging groove) that extends from a first longitudinal end of the push arm 416 to the supporting position of the push arm 416. As shown in FIG. 2B, the pin locking groove 416A accepts insertion of the rotation-restricting pin 411C provided on the guide portion 411A when the guide pin 411B of the guide lever 411 moves along the arc groove 415A of the leading guide groove 415. When the guide lever 411 is further moved toward the left wall 10B and the rotation-restricting pin 411C pushes the pin locking groove 416A, the push arm 416 is rotated toward the left wall 10B. Where facing the right wall 10C, the push arm 416 is additionally provided with a press piece 416B that downwardly protrudes. The press piece 416B is brought into abutment with a push stopper 424D of the later-described slide stopper 424 while the optical disc 1 is clamped on (i.e., held by) the turntable 23, such that the push arm 416 is further rotated toward the left wall 10B as shown in FIG. 2C. With this arrangement, the guide lever 411 is moved away from the periphery of the optical disc 1, so that a predetermined clearance is formed between the guide portion 411A of the guide lever 411 and the optical disc 1.

Between the distal end of the push arm 416 and the bridge plate 413, a push arm-biasing spring 416C (biasing unit) is provided. The push arm-biasing spring 416C inwardly biases the push arm 416 (in other words, biases the guide lever 411 toward the optical disc 1 while the rotation restricting pin 411C is in engagement with the pin locking groove 416A) and inwardly rotates the push arm 416 when the slide stopper 424 is moved away from the press piece 416B. At this time, since the rotation-restricting pin 411C is provided on the guide lever 411 adjacently to the front face 10A, the push arm-biasing spring 416C inwardly biases a front portion the guide lever 411 (i.e., portion adjacent to the front face 10A). With this arrangement, the connecting portion of the guide lever 411 and the disc guide 412 does not protrude toward the left wall 10B when the guide lever 411 is moved, whereby the guide lever 411 can be moved without problems.

The disc-diameter detecting mechanism 42 removes movement restriction of the guide lever 411 of the disc guide mechanism 41 when the optical disc 1 inserted in the slot 11 is the large-diameter disc 1A while restricting the movement of the guide lever 411 when the inserted optical disc 1 is the small-diameter disc 1B.

Specifically, the disc-diameter detecting mechanism 42 includes: a load arm 421 (detector) whose first end abuts on the optical disc 1 and whose second end is rotatable relative to the unit body 10; and an arm link mechanism 422 connected to the load arm 421 for removing the movement restriction of the guide lever 411 when the rotation angle of the load arm 421 is large while restricting the movement of the guide lever 411 when the rotation angle of the load arm 421 is small.

The first end of the load arm 421 is provided with a roller-type abutment portion 421A for abutting on the periphery of the optical disc 1 while the second end of the load arm 421 is rotatably supported by the unit body 10. The load arm 421, which is made of an elongated rectangular plate member, includes a guide groove 421B that extends along the longitudinal direction of the load arm 421. The load arm 421 is biased by a biasing unit (not shown) clockwise so as to return to the initial position as shown in FIG. 1.

The arm link mechanism 422 includes: a substantially-tabular link arm 423 whose first end is provided with a projection 423A guided by the guide groove 421B; and the substantially-tabular slide stopper 424 (restricting unit) whose first end is coupled to the link arm 423.

The load arm 421 and the link arm 423 are located adjacently to the right wall 10C inside the unit body 10 and disposed on substantially the same plane as the guide lever 411 and the disc guide 412 of the disc guide mechanism 41.

A second end of the link arm 423, which is supported in a manner rotatable around a rotary shaft 423B fixed on the unit body 10, is provided with an engaging projection 423C positioned to be opposite to the projection 423A relative to the rotary shaft 423B. In addition, the second end of the link arm 423 (the end where the engaging projection 423C is provided) is provided with a biasing unit (not shown) for biasing the link arm 423 toward the right wall 10C. With this arrangement, the load arm 421 is inwardly biased, i.e., biased clockwise.

The slide stopper 424, which is disposed below the bridge plate 413 to be closer to the rear face 10D than the turntable 23, is movable both in the right and left directions in the drawing(s). A right end of the slide stopper 424 is provided with an oblique abutment portion 424A that is oblique to the inserting/ejecting direction of the optical disc 1 for abutting on the engaging projection 423C. When the large-diameter disc 1A is inserted as the optical disc 1 and the load arm 421 is rotated, the link arm 423 is also rotated, such that the engaging projection 423C is moved toward the front face 10A to press the oblique abutment portion 424A abutting the engaging projection 423C, thereby sliding the slide stopper 424 toward the right wall 10C. In addition, the slide stopper 424 is provided with a restricting stopper 424B adapted to partially block the arm restricting groove 413A of the bridge plate 413. When the slide stopper 424 is moved toward the right wall 10C by the rotation of the load arm 421 as described above, the restricting stopper 424B clears the arm restricting groove 413A, so that the arm restricting pin 414A of the 8 cm arm 414 can be moved along the groove 413A. On the other hand, when the load arm 421 returns to the initial position and the slide stopper 424 returns to the initial position, the restricting stopper 424B blocks the arm restricting groove 413A, thereby preventing the movement of the arm restricting pin 414A. With this arrangement, the rotation of the guide lever 411 coupled to the 8 cm arm 414 is also restricted, thereby allowing the guide lever 411 to be moved toward the left wall 10B.

Adjacently to the front face 10A, the slide stopper 424 is provided with a cam interlocking groove 424C adapted to interlock with the second driving cam 45. With this arrangement, when the second driving cam 45 is moved, the slide stopper 424 is also moved in the right-and-left direction. Adjacently to the left wall 10B, the slide stopper 424 is provided with the push stopper 424D. When the slide stopper 424 is moved toward the left wall 10B by the movement of the second driving cam 45, the push stopper 424D abuts on the press piece 416B of the push arm 416 to restrict the rotation of the push arm 416.

Substantially the center of the slide stopper 424 is opened to provide an ejection-restricting window 424E. The ejection-restricting window 424E includes an ejection-restricting groove 424E1 for the large-diameter disc and an ejection-restricting groove 424E2 for the small-diameter disc that extend in the right-and-left direction. When the slide stopper 424 is moved toward the left wall 10B by the movement of the second driving cam 45, the ejection-restricting grooves 424E1, 424E2 are engaged with an ejection-restricting pin 431A of the later-described assist arm 431, thereby restricting the rotation of the assist arm 431. The ejection-restricting grooves 424E1, 424E2 each have a distal end that is sloped in a direction to be away from the turntable 23. By engaging the sloped portions of the distal ends with the ejection-restricting pin 431A, a clearance can be secured between the ejection arm 434 and the optical disc 1.

The disc ejecting mechanism 43 presses the optical disc 1 toward the slot 11 for ejection. The disc ejecting mechanism 43 includes the assist arm 432 and the ejection arm 432.

As described above, the assist arm 431, which is rotatably provided on the bride plate 413 near the right wall 10C, includes the ejection restricting pin 431A engageable with an assist restricting groove 413B. With this arrangement, the rotation region of the assist arm 431 is restricted to the assist restricting groove 413B. As also described above, the ejection restricting pin 431A, which is inserted in the ejection restricting window 424E, is engaged with the ejection restricting groove 424E1 for the large-diameter disc or the ejection restricting groove 424E2 for the small-diameter disc due to the movement of the slide stopper 424, thereby restricting the rotation of the assist arm 431. An end of the assist arm 431 adjacent to the left wall 10B is provided with a gear 431B. The assist arm 431 is biased by a biasing member (not shown) counterclockwise, i.e., a direction in which the gear 431B is turned toward the front face 10A.

The ejection arm 432, which is rotatably provided on the bridge plate 413 as described above, includes: a gear portion 432A located below the bridge plate 413 while sandwiching the bridge plate 413 against the ejection arm 432; and a longitudinal arm 432B located above the bridge plate 413. The gear portion 432A is meshed with the gear 431B of the assist arm 431 and biased clockwise by biasing force of the assist arm 431. The biasing force biases the arm 432B clockwise, i.e., a direction to press the optical disc 1 to the slot 11. A distal end of the arm 432B is provided with a roller-type abutment portion 432C for abutting on the periphery of the optical disc 1. Further, an arm controlling projection 432D is provided at a position opposite to the arm 432B relative to the rotary center of the ejection arm 432. The arm controlling projection 432D abuts on the periphery of the 8 cm arm 414 when the ejection arm 432 is rotated.

The first driving cam 44 and the second driving cam 45 are respectively provided with engaging grooves that are engaged with locking cam projections (not shown) formed on two laterals of the mount 21. The first driving cam 44 and the second driving cam 45, which are elongated members, are advanced and retracted by a motor and a gear mechanism (not shown) along the longitudinal direction. With this arrangement, the mount 21 is swung so as to be closer to or away from the recording surface of the optical disc 1 mounted on the turntable 23.

The link arm 423 and the first driving cam 44 each include a disc transferring cam 51 for decreasing a transfer amount of the optical disc 1 to be transferred to the turntable 23 when the optical disc 1 is the large-diameter disc 1A and for increasing the transfer amount of the optical disc 1 to be transferred to the turntable 23 when the optical disc 1 is the small-diameter disc 1B.

The disc transferring cam 51 includes a projection 52 provided on the link arm 423, and a cam groove 53 provided on the first driving cam 44 to be engageable with the projection 52.

The cam groove 53 includes: a first cam groove 53A for transferring the large-diameter disc 1A; a second cam groove 53B for transferring the small-diameter disc 1B; and a common cam groove 53C whose one end is linked with the first cam groove 53A and the second cam groove 53B. The first cam groove 53A and the second cam grove 53B extend in a direction of the movement of the first driving cam 44.

The second driving cam 45, which is coupled to the first driving cam 44, advances and retracts in the right-and-left direction in interlock with the advancement and retraction of the first driving cam 44. When a sensor (not shown) detects that the center of the optical disc 1 is located above the turntable 23, the first driving cam 44 is moved toward the rear face 10D and the second driving cam 45 is moved toward the left wall 10B. The movement of the second driving cam 45 moves the mount 21 closer to the recording surface of the optical disc 1, such that the optical disc 1 is clamped on the turntable 23. The turntable 23 is rotated in this state, such that information is recorded and/or reproduced in or from the optical disc 1.

[Operation of Disc Unit]

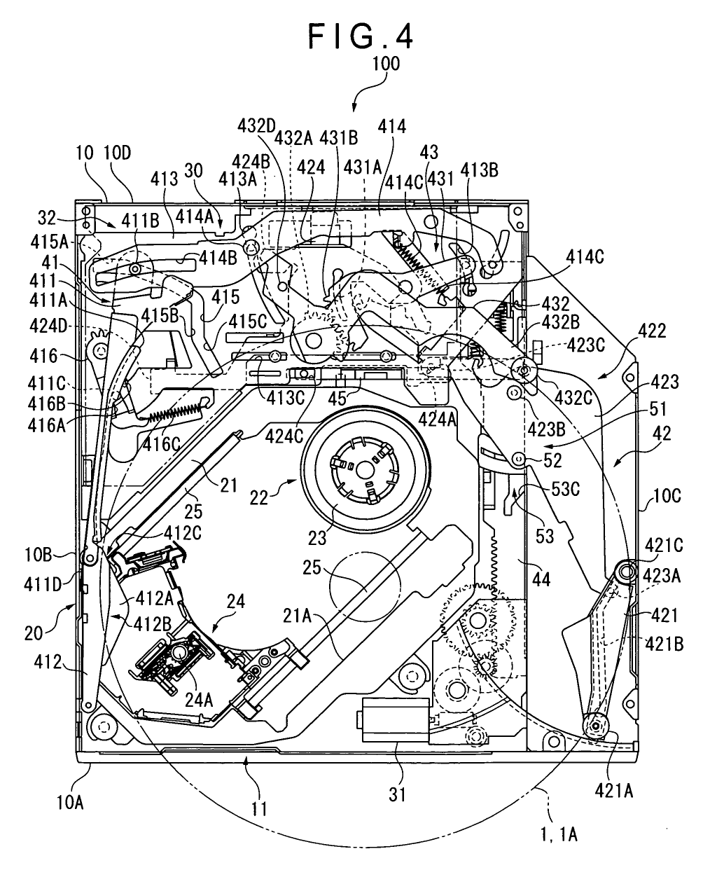

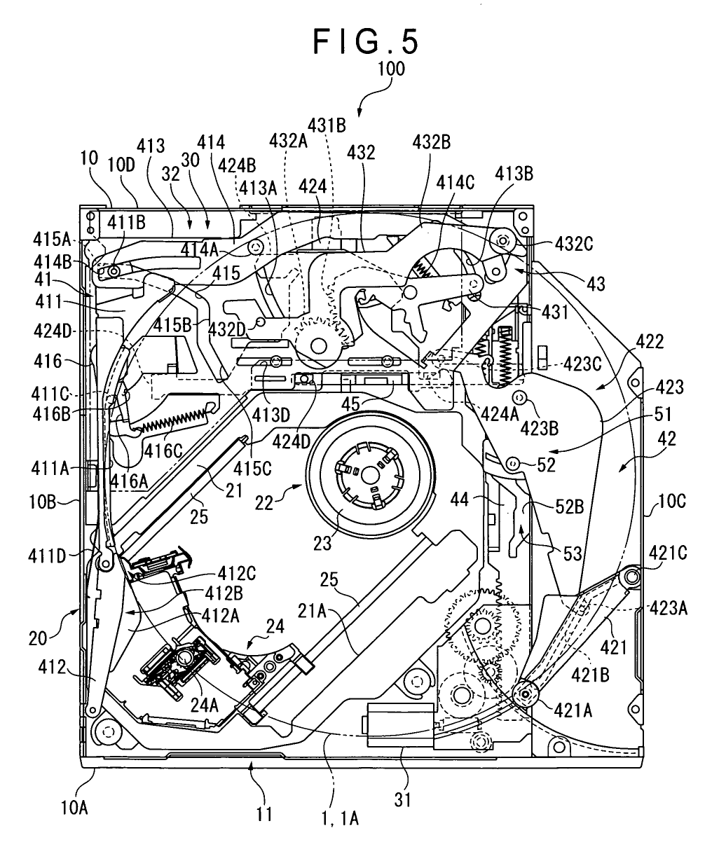

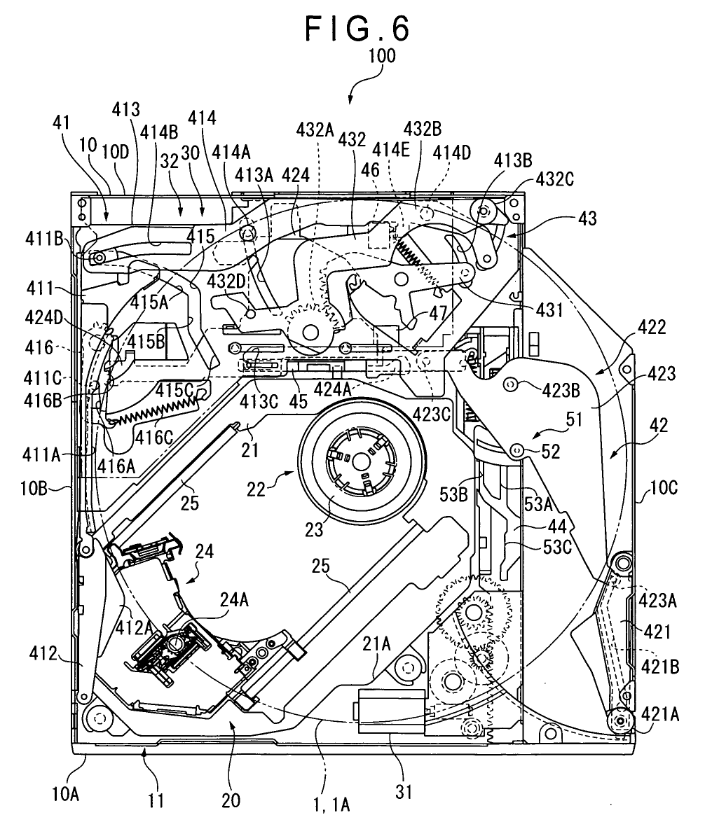

Next, operation(s) of the disc unit 100 will be described by reference to FIGS. 1 to 6. FIG. 3 is a top view showing the inside of the unit body of the disk unit when the insertion of the large-diameter disc is initiated or when the ejection of the large-diameter disc is completed. FIG. 4 is a top view showing the inside of the unit body of the disk unit when the large-diameter disc is being transferred. FIG. 5 is a top view showing the inside of the unit body of the disk unit when a disc (large-diameter disc) has been inserted. FIG. 6 is a top view showing the inside of the unit body of the disk unit when the large-diameter disc has been clamped on the turntable.

(Insertion of Large-Diameter Disc)

Operation(s) of the disc unit when the large-diameter disc 1A having a disc diameter of 12 cm is inserted in the disc unit 100 in the initial state shown in FIG. 1 will be explained below. When the large-diameter disc 1A is inserted in the slot 11 of the disc unit 100 in the initial state, the periphery of the large-diameter disc 1A presses the abutment portion 421A of the load arm 421 toward the right wall 10C as shown in FIG. 3, thereby rotating the load arm 421. With this operation, the link arm 423 is rotated counterclockwise, such that the slide stopper 424 is slid toward the right wall 10C. The movement of the slide stopper 424 disengages the restricting stopper 424B from the arm restricting groove 413A of the bridge plate 413, thereby removing regulation of the rotation region of the 8 cm arm 414.

When the large-diameter disc 1A is further inserted in the unit in this state, the periphery of the large-diameter disc 1A laterally abuts on the slide contact surface 412B of the disc guide 412 as shown in FIG. 4, thereby rotating the disc guide 412 toward the left wall 10B. At this time, the guide lever 411 is also pressed toward the rear face 10D, thereby moving the guide pin 411B from the oblique groove 415C and the linear groove 415B of the leading guide groove 415 to the arc groove 415A. Then, with the guide pin 411B moving toward the left wall 10B along the arc groove 415A, the guide lever 411 is moved toward the left wall 10B while remaining substantially parallel to the disc inserting/ejecting direction, so that the guide portion 411A guides the periphery of the large-diameter disc 1A. In addition, the rotation-restricting pin 411C of the guide portion 411A is engaged with the pin locking groove 416A of the push arm 416 at this time, such that the push arm 416 is also rotated toward the left wall 10B.

When a half or more of the large-diameter disc 1A has been subsequently inserted in the unit body 10, the inwardly-biased load arm 421 (i.e., biased clockwise) is moved along the periphery of the large-diameter disc 1A. Then, the load arm 421 presses the large-diameter disc 1A from the front face 10A toward the rear face 10D by the biasing force applied on the load arm 421. When the half or more of the large-diameter disc 1A subsequently passes the connecting portion of the guide lever 411 and the disc guide 412, the guide lever 411 is slanted by the inwardly-biased plate spring 411D such that a portion of the lever 411 adjacent to the front face 10A inwardly protrudes, thereby guiding the large-diameter disc 1A further into the unit body 10.

When the center of the large-diameter disc 1A is transferred to the above of turntable 23 as shown in FIG. 5, the mount 21 is upwardly moved by the movement of the first driving cam 44 and the second driving cam 45, such that the large-diameter disc 1A is clamped on the turntable 23 as shown in FIG. 6. More specifically, the insertion of the large-diameter disc 1A presses an insertion detecting switch (not shown), such that the first driving cam 44 moved toward the front face 10A. At this time, the projection 52 is inserted into the first cam groove 53A of the first driving cam 44, thereby fixing the position of load arm 421 while maintaining a clearance between the load arm 421 and the large-diameter disc 1A. The second driving cam 52 is also moved toward the left wall 10B in interlock with the movement of the first driving cam 44. Then, the mount 21 is upwardly moved in interlock with the first and second driving cams 44, 45, thereby clamping the large-diameter disc 1A on the turntable 23.

By moving the second driving cam 45 toward the left wall 10B, the slide stopper 424 is also moved toward the left wall 10B. With this operation, the push stopper 424D presses the press piece 416B of the push arm 416 toward the left wall 10B, thereby restricting the movement of the push arm 416. The guide lever 411, whose rotation-restricting pin 411C has been locked with the pin locking groove 416A, is consequently pressed toward the left wall 10B, thereby providing a clearance of a predetermined size between the guide lever 411 and the large-diameter disc 1A.

In addition, the ejection restricting pin 431A of the assist arm 431 is engaged with the ejection-restricting groove 424E1 for the large-diameter disc by the movement of the slide stopper 424, thereby restricting the movement of the abutment portion 432C of the ejection arm 432 while providing a clearance of a predetermined size between the abutment portion 432C and the large-diameter disc 1A.

(Ejection of Large-Diameter Disc)

Next, operation(s) of ejecting the large-diameter disc 1A will be described. When, for example, an operator presses an ejection button, the first driving cam 44 is initially moved toward the rear face 10D, such that the second driving cam 45 is also moved toward the right wall 10C in interlock with the first driving cam 44. With this operation, the mount 21 is downwardly moved to stop clamping the large-diameter disc 1A. In addition, with the second driving cam 45 being moved toward the right wall 10C, the slide stopper 424 is also moved toward the right wall 10C, such that the push stopper 424D is moved away from the push arm 416. Then, the push arm 416 is inwardly rotated (i.e., toward the right wall 10C) by the biasing force of the push arm-biasing spring 416C. With this operation, the guide portion 411A of the guide lever 411 abuts on the periphery of the large-diameter disc 1A to hold the optical disc 1A. With the movement of the slide stopper 424 toward the right wall 10C, the ejection arm 432 and the load arm 421 also become free from the movement restriction in the same manner to hold the periphery of the large-diameter disc 1A. Then, the biasing force of the ejection arm 432 presses the large-diameter disc 1A toward the front face 10A.

When the left-lateral periphery of the large-diameter 1A passes the connecting portion of the guide lever 411 and the disc guide 412 to be further ejected toward the front face 10A, the pressing portion 412C of the disc guide 412 presses the periphery of the large-diameter disc 1A toward the front face 10A. Specifically, when the guide pin 411B is pressed by the 8 cm arm 414 toward the front face 10A to pass the linear groove 415B, the guide lever 411 is also pressed toward the front face 10A. At this time, the connecting portion of the guide lever 411 and the disc guide 412 inwardly protrudes along the rotation arc of the disc guide 412, such that the guide lever 411 is slanted. With this operation, the end of the guide lever 411 adjacent to the front face 10A can press the periphery of the large-diameter disc 1A. When the guide pin 411B further passes the oblique groove 415C, the guide lever 411 is moved to protrude more inwardly, thereby promoting the ejection of the large-diameter disc 1A.

On the other hand, when the right-lateral periphery of the large-diameter disc 1A passes the abutment portion 421A of the load arm 421 to be further ejected toward the front face 10A, the first driving cam 44 is further moved toward the rear face 10D, such that the projection 52 is engaged with the common cam groove 53C and the load arm 421 is inwardly rotated. The rotation of the load arm 421 presses the large-diameter disc 1A toward the front face 110A, thereby ejecting the large-diameter disc 1A.

[Effect and Advantage of Disc Unit]

As described above, the disc unit 100 according to the above embodiment includes the push arm 416 for providing the predetermined clearance between the periphery of the large-diameter disc 1A and the guide lever 411 by moving the guide lever 411 for guiding the insertion and ejection of the large-diameter disc 1A toward the left wall 10B when the large-diameter disc 1A is clamped on the turntable 23. With this arrangement, when the large-diameter disc 1A is mounted on the turntable 23, the guide lever 411 does not hinder the rotation of the large-diameter disc 1A. Accordingly, the large-diameter disc 1A can be favorably clamped, thereby avoiding such errors as a reading error due to the rotation hindrance.

The push arm 416 is inwardly biased, i.e., biased to be rotated toward the mounting position of the large-diameter disc 1A, by the push arm-biasing spring 416C. With this arrangement, when the large-diameter disc 1A is not clamped on the turntable 23 while the rotation-restriction pin 411C is in engagement with the pin locking groove 416A, the guide lever 411 is constantly biased inwardly by the push arm 416. Accordingly, the guide lever 411 can reliably hold the large-diameter disc 1A and also favorably guide the large-diameter disc 1A with the guide portion 411A.

The first end of the push arm 416 is rotatable relative to the bridge plate 413 while the second end of the push arm 416 is inwardly biased by the push arm-biasing spring 416C. Accordingly, the movement region of the push arm 416 can be made small, such that the movement of the guide lever 411 can be restricted with a simple arrangement.

The push arm 416 includes the pin locking groove 416A with which the rotation-restricting pin 411C provided on the guide lever 411 is engaged. When the guide lever 411 is moved toward the left wall 10B, the rotation-restricting pin 411C is engaged with the pin locking groove 416A to restrict the movement of the guide lever 411. Accordingly, the push arm 416 can restrict the movement of the guide lever 411 by simply engaging the rotation-restricting pin 411C of the guide lever 411 with the groove 416A.

According to the present embodiment, the disc unit 100, in which the guide lever 411 is moved along the arc groove 415A substantially parallel to the inserting/ejecting direction of the optical disc 1, employs the above-described push arm 416 that includes the rotatably-mounted first end and the pin locking groove 416A extending from its second end to the rotary center. Accordingly, by engaging the rotation-restricting pin 411C of the guide lever 411 with the pin locking groove 416A, the push arm 416 can restrict the movement of the guide lever 411 with the minimum movement. Thus, the size of the push arm 416 can be reduced and the arrangement can be simplified, thereby contributing to size reduction and thickness reduction of the disc unit 100.

The rotation-restricting pin 411C is provided on the guide lever 411 adjacently to the front face 10A. With this arrangement, the connecting portion of the guide lever 411 and the disc guide 412 is prevented from being rotated outwardly, i.e., toward the left wall 10B.

The rotation-restricting pin 411C is positioned not to interfere with the mount 21 when the guide lever 411 is guiding the small-diameter disc 1B. Specifically, even the mount 21 is upwardly moved to clamp the small-diameter disc 1B on the turntable 23, the rotation-restricting pin 411C does not contact the mount 21. Accordingly, it is possible to prevent errors such as a clamping error caused by contacting of the mount 21 and the rotation-restricting pin 411C or an information-processing error of the small-diameter disc 1B.

[Modifications of Embodiment]

It should be noted that the present invention is not limited to the exemplary embodiments described above, but may include modifications described below within a scope where an object of the present invention can be achieved.

Although the rotation-restricting pin 411C to be engaged with the pin locking groove 416A of the push arm 416 is exemplarily provided on the guide lever 411 adjacently to the front face 10A, positioned not to interfere with the mount 21 and protrudes downwardly in the above embodiment, the arrangement of the rotation-restricting pin 411C is not limited thereto. For instance, since the rotation-restricting pin 411C does not contact the mount 21 when upwardly protruding from the guide lever 411, the rotation-restricting pin 411C may be provided on the guide lever 411 adjacently to the front face 10A. At this time, the push arm 416 may be provided at an upper position corresponding to the rotation-restricting pin 411C.

Although the rotation-restricting pin 411C is provided on the guide lever 411 adjacently to the front face 10A, the pin 411C may be provided thereon adjacently to the rear face 10D. At this time, in order not to outwardly rotate the connecting portion of the guide lever 411 and the disc guide 412, another rotation-restricting member or another biasing member for preventing the outward protrusion and outward rotation of the connecting portion may be provided.

Although the rotation-restricting pin 411C of the guide lever 411 is exemplarily engaged with the pin locking groove 416A provided to the push arm 416 in the above embodiment, another arrangement may be employed in which, for example, a locking pin is provided on the push arm 416 while a groove to be engaged with this pin is formed on the guide lever 411. According to such an arrangement, since the pin does not interfere with the mount, the push arm 416 may be provided more adjacently to the front face 10A. With this arrangement, the outward rotation of the connecting portion of the guide lever 411 and the disc guide 412 can be more reliably prevented.

Although the first end of the push arm 416 is exemplarily supported to be rotatable relative to the bridge plate 413 while the second end of the push arm 416 is exemplarily provided with the push arm-biasing spring 416C in the above embodiment, the arrangement of the push arm 416 is not limited thereto. As long as the push arm 416 is moved in a direction crossing the movement direction of the guide lever 411, the push arm 416 may be, for instance, a member that is moved parallel in the same direction as the right-and-left direction of the guide lever 411. By moving such a member toward the left wall 10B while being engaged with the rotation-restricting pin 411C of the guide lever 411, the guide lever 411 can be moved toward the left wall 10B.

Although the slide stopper 424 exemplarily serves as the movement restricting member, the arrangement is not limited thereto. For instance, a mount interlocking member connected to the mount 21 for moving the push arm 416 toward the left wall 10B in accordance with the up-and-down movement of the mount 21 may be provided.

Specific configurations when implementing the present invention may be other configurations or the like as long as an object of the present invention can be attained.

[Effects and Advantages of Embodiment]

The disc unit 100 according to the above embodiment includes the push arm 416 for providing the predetermined clearance between the periphery of the large-diameter disc 1A and the guide lever 411 by moving the guide lever 411 for guiding the insertion and ejection of the large-diameter disc 1A toward the left wall 10B when the large-diameter disc 1A is clamped on the turntable 23. With this arrangement, when the large-diameter disc 1A is mounted on the turntable 23, the guide lever 411 does not hinder the rotation of the large-diameter disc 1A. Accordingly, the large-diameter disc 1A can be favorably clamped, thereby avoiding such errors as a reading error due to the rotation hindrance.

### INDUSTRIAL APPLICABILITY

The present invention is applicable to a transfer unit for inserting and ejecting a disc recording medium and a recording-medium driver provided with the transfer unit.

1. A transfer unit, comprising:
a guide member that guides a disc recording medium to a position where a disc holder disposed inside a unit body is capable of holding the recording medium, the guide member being movable in a direction to be close to or away from the recording medium;
a guide-movement controlling member that moves the guide member away from the recording medium while the disc holder holds the recording medium, wherein
the guide-movement controlling member comprises: a guide engaging member engageable with the guide member; and a movement restricting member that restricts a movement of the guide engaging member with the guide engaging member being in engagement with the guide member while the disc holder holds the recording medium,
the guide member longitudinally extends substantially parallel to a transfer direction of the recording medium and the guide member comprises: a guide lever having an engaging portion engageable with the guide engaging member; and a disc guide whose first end is rotatable provided on the unit body and whose second end is rotatably connected to a first end of the guide lever, and
the guide engaging member comprises an engaging groove adapted to be engaged with the engaging portion by a movement of the guide engaging member.

2. The transfer unit according to claim 1, wherein the guide-movement controlling member biases the guide member toward the recording medium while the disc holder does not hold the recording medium.

3. (canceled)

4. The transfer unit according to claim 1, wherein a first end of the guide engaging member is rotatably provided on the unit body while a second end of the guide engaging member is provided with a biasing member that biases the guide engaging member toward the recording medium.

5. (canceled)

6. The transfer unit according to claim 1, wherein the engaging portion is provided adjacently to a connecting portion that connects the guide lever to the disc guide.

7. The transfer unit according to claim 1, wherein the engaging portion is provided at such a position as not to interfere with a mount on which the disc holder is provided while the disc holder holds the recording medium.

8. A recording medium driver, comprising:
the transfer unit according to claim 1;
the disc holder that holds the recording medium transferred by the transfer unit;
a mount on which the disc holder is provided, the mount being movable in an up-and-down direction;
an information processor that performs at least one of writing information in the recording medium held by the disc holder and reading information from the recording medium; and
the unit body that internally houses the transfer unit, the disc holder, the mount and the information processor, the unit body comprising an insertion-and-ejection opening for inserting and ejecting the recording medium.
